(19) United States
(12) Patent Application Publication
(10) Pub. No.: US 2025/0388092 A1
(43) Pub. Date: Dec. 25, 2025

(54) DRIVE DEVICE FOR ELECTRIFIED VEHICLE

(71) Applicant: Toyota Jidosha Kabushiki Kaisha, Toyota-shi (JP)

(72) Inventor: Toru SHIBAMOTO, Okazaki-shi (JP)

(73) Assignee: Toyota Jidosha Kabushiki Kaisha, Toyota-shi (JP)

(21) Appl. No.: 19/066,359

(22) Filed: Feb. 28, 2025

(30) Foreign Application Priority Data
Jun. 21, 2024 (JP) 2024-100617

(51) Int. Cl. B60L 15/20; B60K 17/16; B60L 50/60

(52) U.S. Cl. CPC B60L 15/20; B60K 17/165; B60L 50/60; B60L 2240/427

(57) ABSTRACT

A drive device for an electrified vehicle includes a motor having a rotor attached to a motor shaft and a stator wound with a motor coil, an inverter that drives the motor by switching of a switching element, a shaft voltage sensor that detects a shaft voltage of the motor shaft, a choke coil attached to a power transmission path from the motor shaft to drive wheels, and an application control device that applies a current to the choke coil to cancel at least a part of electromagnetic noise transmitted to the drive wheels through the power transmission path when a predetermined pulsation of the shaft voltage is detected based on a detection value of the shaft voltage sensor.

### CROSS-REFERENCE TO RELATED APPLICATION

This application claims priority to Japanese Patent Application No. 2024-100617 filed on Jun. 21, 2024. The disclosure of the above-identified application, including the specification, drawings, and claims, is incorporated by reference herein in its entirety.

### BACKGROUND

### 1. Technical Field

The present disclosure relates to a drive device for an electrified vehicle.

### 2. Description of Related Art

A drive device for an electrified vehicle that includes a motor having a rotor attached to a motor shaft and a stator around which a motor coil is wound is proposed (for example, see Japanese Unexamined Patent Application Publication No. 2014-147293 (JP 2014-147293 A)). The drive device for an electrified vehicle includes an inverter that drives the motor. The drive device for an electrified vehicle includes a power transmission coupling portion that is provided in a power transmission path from the motor shaft to drive wheels and that provides an electrical resistance at a position downstream of the motor shaft. The power transmission coupling portion includes a spline fitting portion and a gear meshing portion. The drive device for an electrified vehicle includes a ground connection body that electrically connects a vehicle body to a position downstream of the power transmission coupling portion in the power transmission path. In the drive device for an electrified vehicle, the ground connection body includes a sliding contact brush that slides into contact with a shaft end portion of a counter shaft of a gear reducer in the power transmission path. The ground connection body has a lead wire that electrically connects the sliding contact brush and a gear case of the gear reducer and a connection line that electrically connects the gear case and the vehicle body. The shaft end portion is covered with a brush cover fixed to the gear case, and a brush chamber communicating with an inner chamber of the gear case is formed by the brush cover. In the drive device for an electrified vehicle, propagation of noise from the inverter via the motor to the power transmission path is reduced, thereby reducing high-frequency noise radiated to an outside.

### SUMMARY

In the drive device for an electrified vehicle, the brush chamber and the like are provided separately from the inner chamber of the gear case, and a space is increased, resulting in enlargement of the device. When the device is enlarged, there is a possibility that a space of an occupant room is narrowed.

A drive device for an electrified vehicle according to the present disclosure suppresses transmission of relatively large electromagnetic noise to the drive wheels through the power transmission path accompanying discharge of a shaft voltage of the motor shaft when the discharge occurs, while suppressing enlargement of the device.

A drive device for an electrified vehicle according to an aspect of the present disclosure is configured as follows.

An aspect of the present disclosure relates to a drive device for an electrified vehicle. The drive device includes a motor, an inverter, a shaft voltage sensor, a choke coil, and an application control device. The motor has a rotor attached to a motor shaft and a stator around which a motor coil is wound. The inverter is configured to drive the motor through switching of a switching element. The shaft voltage sensor is configured to detect a shaft voltage of the motor shaft. The choke coil is attached to a power transmission path from the motor shaft to drive wheels. The application control device is configured to apply a current to the choke coil to cancel at least a part of electromagnetic noise transmitted to the drive wheels through the power transmission path when a predetermined pulsation of the shaft voltage is detected based on a detection value of the shaft voltage sensor.

In the drive device for an electrified vehicle according to the present disclosure, the choke coil is attached to the power transmission path from the motor shaft to the drive wheels. When the predetermined pulsation of the shaft voltage is detected based on the detection value of the shaft voltage sensor configured to detect the shaft voltage of the motor shaft, a current is applied to the choke coil to cancel at least a part of the electromagnetic noise transmitted to the drive wheels through the power transmission path. When the discharge of the shaft voltage of the motor shaft occurs, a relatively large pulsation of the shaft voltage occurs. Therefore, with the above-mentioned control, the transmission of relatively large electromagnetic noise to the drive wheels through the power transmission path accompanying discharge of the shaft voltage of the motor shaft when the discharge occurs can be suppressed, along with suppression of the enlargement of the device. Here, the “predetermined pulsation of the shaft voltage” may include solely the pulsation of the shaft voltage caused by the discharge of the shaft voltage, or may include the pulsation of the shaft voltage caused by the switching of the switching element of the inverter in addition to the pulsation of the shaft voltage caused by the discharge of the shaft voltage.

In the drive device according to the aspect, the application control device may be configured to detect the predetermined pulsation of the shaft voltage when the detection value of the shaft voltage or a filtered value obtained by subjecting the detection value to filter processing reaches a threshold value or more.

In this case, the threshold value may be determined in advance as a value that is larger than the detection value or the filtered value when the switching occurs in the inverter and that is smaller than the detection value or the filtered value when the shaft voltage is discharged.

In the drive device according to the aspect, the motor shaft may be connected to the drive wheels via a gear mechanism, a differential gear, and a drive shaft, and the choke coil may be attached to any one of the motor shaft, a shaft of the gear mechanism, and the drive shaft.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery electric vehicle equipped with a drive device for an electrified vehicle according to an embodiment of the present disclosure;

FIG. 2 is a schematic configuration diagram of an electric drive system including a motor and an inverter, and an ECU;

FIG. 3 is a flowchart showing an example of a processing routine executed by the ECU; and

FIG. 4 is a descriptive view showing an example of the appearance of the shaft voltage Vs of the motor shaft and the filtered value Vsf.

### DETAILED DESCRIPTION OF EMBODIMENTS

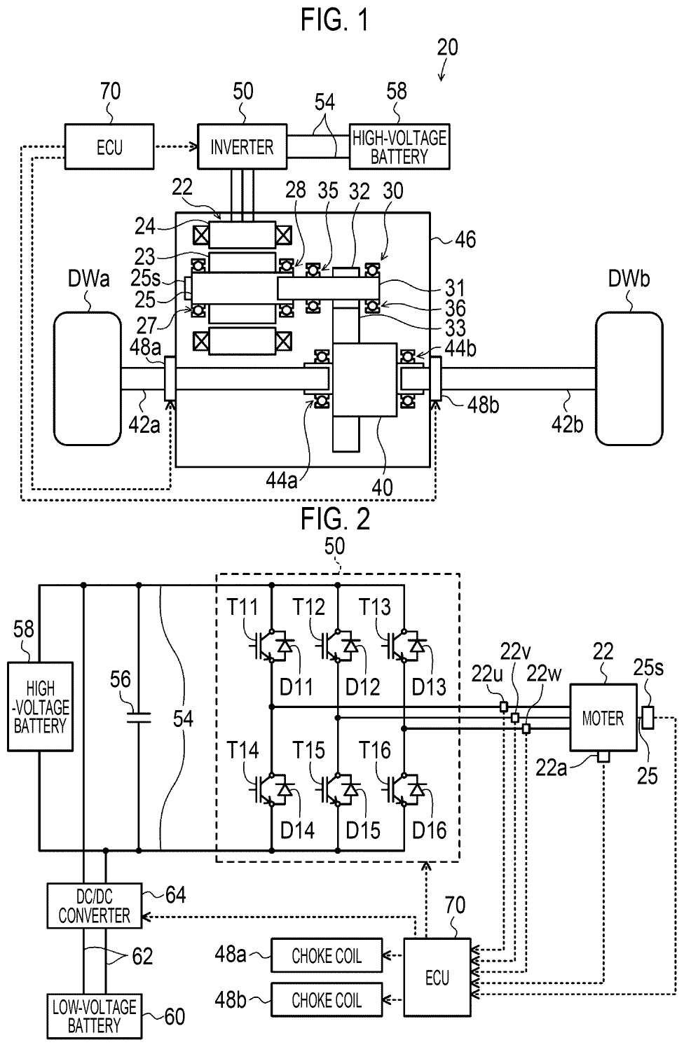

An embodiment for carrying out the present disclosure will be described with reference to the drawings. FIG. 1 is a schematic configuration diagram of a battery electric vehicle 20 equipped with a drive device for an electrified vehicle according to an embodiment of the present disclosure. FIG. 2 is a schematic configuration diagram of an electric driving system and an electronic control unit (hereinafter, referred to as “ECU”) 70 including the motor 22 and the inverter 50. As shown in FIG. 1 or 2, the battery electric vehicle 20 of the embodiment includes a motor 22, a gear mechanism 30, a differential gear 40, and drive shafts 42a, 42b. The battery electric vehicle 20 includes an inverter 50, a high-voltage battery 58, a low-voltage battery 60, a DC/DC converter 64, and an ECU 70 (application control device). The motor 22, the gear mechanism 30, the differential gear 40, the drive shafts 42a, 42b, and the bearings 27, 28, 35, 36, 44a, 44b described below are made of a metal (conductor). The motor 22, the gear mechanism 30, the differential gear 40, a part of the drive shafts 42a, 42b (a portion on the differential gear 40 side), and the bearings 27, 28, 35, 36, 44a, 44b are housed in a case (housing) 46.

The motor 22 is configured as a synchronous motor generator, and includes a rotor 23 in which a permanent magnet is embedded in a rotor core, and a stator 24 in which three-phase (U-phase, V-phase, W-phase) coils are wound around a stator core, for example. The rotor 23 is attached to the motor shaft 25. The motor shaft 25 is rotatably supported by the case 46 via bearings 27, 28.

The gear mechanism 30 includes a counter shaft 31, a counter gear 32 attached to the counter shaft 31, and a final gear 33 that meshes with the counter gear 32 and is connected to a differential gear 40. The counter shaft 31 is connected to the motor shaft 25 in coaxial relation by spline fitting or the like. The final gear 33 is a differential ring gear. The counter shaft 31 is connected to the motor shaft 25 by spline fitting or the like, and is rotatably supported by the case 46 through bearings 35, 36. The differential gear 40 is connected to the drive wheels DWa, DWb via drive shafts 42a, 42b. The drive shafts 42a, 42b are rotatably supported by the case 46 through the bearings 44a, 44b, respectively. A choke coil 48a, 48b is attached to each of the drive shafts 42a, 42b.

As shown in FIG. 2, the inverter 50 is connected to a high-voltage system power line 54. The inverter 50 includes six transistors T11 to T16 as switching elements, and six diodes D11 to D16 connected in parallel to the transistors T11 to T16, respectively. The transistors T11 to T16 are disposed in pairs such that the transistors T11 to T16 are source side and sink side with respect to the positive electrode line and the negative electrode line of the high-voltage system power line 54. Each of connection points of two transistors corresponding to the transistors T11 to T16 is connected to each of the three-phase (U-phase, V-phase, W-phase) coils of the motor 22. A capacitor 56 for smoothing is connected to the high-voltage system power line 54.

The high-voltage battery 58 is configured as, for example, a lithium ion secondary battery or a nickel-hydrogen secondary battery having a rated voltage of about several hundred V, and is connected to the high-voltage system power line 54. The low-voltage battery 60 is configured as, for example, a lithium ion secondary battery or a lead storage battery having a rated voltage of 12 V, and is connected to the low-voltage system power line 62 together with the ECU 70, various accessories, and the like. The DC/DC converter 64 steps down the power of the high-voltage system power line 54 and supplies the stepped-down power to the low-voltage system power line 62.

The ECU 70 includes a microcomputer having a CPU, a ROM, a RAM, a flash memory, an input/output port, and a communication port, or various drive circuits and various logic ICs. The ECU 70 receives signals from various sensors. The various sensors are, for example, a rotation position sensor 22a that detects a rotation position θm of a rotor of the motor 22. The various sensors are, for example, current sensors 22u, 22v, 22w that detect phase currents Iu, Iv, Iw flowing through each phase (U phase, V phase, W phase) of the motor 22. The various sensors are, for example, a shaft voltage sensor 25s that detects a shaft voltage Vs of the motor shaft 25. Although not shown, the various sensors are, for example, a shift position sensor that detects a shift position SP that is a shift position of a shift lever. Although not shown, the various sensors are, for example, an accelerator pedal position sensor that detects an accelerator operation amount Acc that is an accelerator pedal depression amount. Although not shown, the various sensors are, for example, a brake pedal position sensor that detects a brake pedal position BP, which is a brake pedal depression amount. Although not shown, the various sensors are, for example, a vehicle speed sensor that detects a vehicle speed V. The shaft voltage Vs of the motor shaft 25 includes a ground-to-shaft voltage. The ECU 70 performs switching control of transistors T11 to T16 of the inverter 50, energization control of the choke coils 48a, 48b, and control of the DC/DC converter 64.

In the battery electric vehicle 20, the ECU 70 sets the request torque Td* requested for traveling based on the accelerator operation amount Acc and the vehicle speed V. The ECU 70 sets the torque command Tm* of the motor 22 such that the vehicle travels by the set request torque Td*. The ECU 70 performs switching control of the transistors T11 to T16 of the inverter 50 such that the motor 22 is driven with the torque command Tm*.

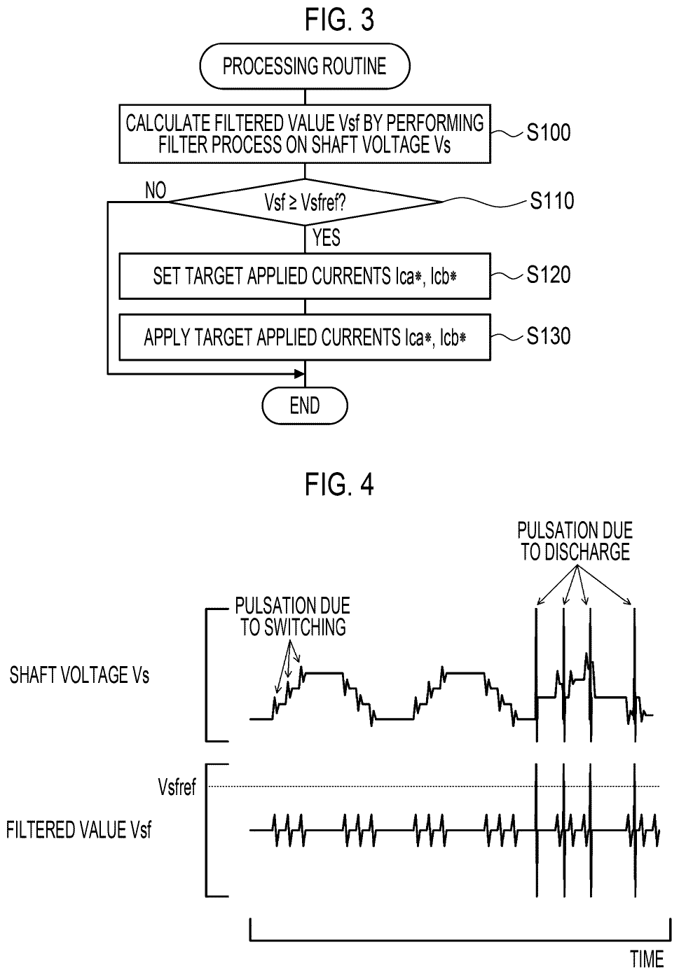

Next, the operation of the battery electric vehicle 20 of the embodiment, particularly, the energization control of the choke coils 48a, 48b will be described. FIG. 3 is a flowchart showing an example of a processing routine executed by the microcomputer of the ECU 70. The routine is repeatedly executed.

When the routine is executed, the ECU 70 first executes filter processing on the shaft voltage Vs of the motor shaft 25 detected by the shaft voltage sensor 25s to calculate a filtered value Vsf of the shaft voltage Vs (S100). In this process, specifically, high-pass filter processing of extracting a frequency component higher than a predetermined frequency is performed on the shaft voltage Vs of the motor shaft 25 to calculate a filtered value Vsf. FIG. 4 is a descriptive view showing an example of the appearance of the shaft voltage Vs of the motor shaft 25 and the filtered value Vsf. As can be seen from FIG. 4, pulsation of the shaft voltage Vs or the filtered value Vsf is generated due to the switching of the transistors T11 to T16 of the inverter 50 or the discharge of the shaft voltage of the motor shaft 25. The pulsation of the shaft voltage Vs or the pulsation of the filtered value Vsf due to the discharge of the shaft voltage of the motor shaft 25 is large as compared with the pulsation of the shaft voltage Vs or the pulsation of the filtered value Vsf due to the switching of the transistors T11 to T16. It is considered that the discharge of the shaft voltage is performed, for example, by the current flowing from the motor shaft 25 to the case 46 through the bearings 27, 28, 35, 36 and the like, which are the power transmission paths to the drive wheels DWa, DWb. In the figure, “Vsfref” will be described later.

After the filtered value Vsf is calculated in this way, the calculated filtered value Vsf is compared with a threshold value Vsfref (S110). Here, the threshold value Vsfref is a threshold value for detecting the discharge of the shaft voltage of the motor shaft 25 (a predetermined pulsation of the shaft voltage caused by the discharge). The threshold value Vsfref is a value larger than the maximum value of the filtered value Vsf when the transistors T11 to T16 of the inverter 50 are switched. In addition, the threshold value Vsfref is a value smaller than the maximum value of the filtered value Vsf when the shaft voltage of the motor shaft 25 is discharged. The threshold value Vsfref is determined in advance by an experiment, analysis, machine learning, or the like. When the filtered value Vsf is less than the threshold value Vsfref, the routine ends without detecting the discharge of the shaft voltage of the motor shaft 25.

When the filtered value Vsf in S110 is equal to or greater than the threshold value Vsfref, the discharge of the shaft voltage of the motor shaft 25 is detected, and the target applied currents Ica*, Icb* to be applied to the choke coils 48a, 48b are set (S120). Then, the set target applied currents Ica*, Icb* are applied to the choke coils 48a, 48b (S130), and the present routine is terminated. Here, the target applied currents Ica*, Icb* are determined as currents (current waveforms) for canceling at least a part of the electromagnetic noise. The electromagnetic noise is transmitted to the drive wheels DWa, DWb from the motor shaft 25 via the power transmission path from the motor shaft 25 to the drive wheels DWa, DWb when the discharge of the shaft voltage of the motor shaft 25 occurs. The target applied currents Ica*, Icb* may use a uniform frequency or current value determined in advance. The target applied currents Ica*, Icb* may be determined based on the maximum value of the filtered value Vsf and the like. The target applied currents Ica*, Icb* may be determined based on a change amount (change rate) of the filtered value Vsf per unit time when the filtered value Vsf reaches or exceeds a threshold value Vsfref. With such control, it is possible to suppress the transmission of a relatively large electromagnetic noise to the drive wheels DWa, DWb through the power transmission path when the discharge of the shaft voltage of the motor shaft 25 occurs due to the discharge.

In the battery electric vehicle 20 according to the embodiment described above, the filter processing is performed on the shaft voltage Vs of the motor shaft 25 detected by the shaft voltage sensor 25s to calculate the filtered value Vsf. Then, when the calculated filtered value Vsf is equal to or greater than the threshold value Vsfref, the discharge of the shaft voltage of the motor shaft 25 is detected, and the target applied currents Ica*, Icb* to be applied to the choke coils 48a, 48b are set. Then, the set target applied currents Ica*, Icb* are applied to the choke coils 48a, 48b. The target applied currents Ica*, Icb* are determined as currents (current waveforms) for canceling at least a part of electromagnetic noise. The electromagnetic noise is transmitted to the drive wheels DWa, DWb from the motor shaft 25 via the power transmission path from the motor shaft 25 to the drive wheels DWa, DWb when the discharge of the shaft voltage of the motor shaft 25 occurs. As a result, it is possible to suppress the transmission of a relatively large electromagnetic noise to the drive wheels DWa, DWb through the power transmission path when the discharge of the shaft voltage of the motor shaft 25 occurs. In addition, the device can be suppressed from being increased in size as compared with the device in which the brush chamber and the like are provided separately from the inner chamber of the gear case as in the above Japanese Unexamined Patent Application Publication No. 2014-147293.

In the above-described embodiment, the filtered value Vsf calculated by performing the filter processing on the shaft voltage Vs of the motor shaft 25 is set to detect the discharge of the shaft voltage of the motor shaft 25 when the filtered value Vsf is equal to or greater than the threshold value Vsfref. The shaft voltage Vs of the motor shaft 25 is detected by a shaft voltage sensor 25s. However, the discharge of the shaft voltage of the motor shaft 25 may be detected when the shaft voltage Vs of the motor shaft 25 is equal to or greater than the threshold value Vsref. The threshold value Vsref is a value larger than the maximum value of the shaft voltage Vs when the transistors T11 to T16 of the inverter 50 are switched. In addition, the threshold value Vsref is a value smaller than the maximum value of the shaft voltage Vs when the shaft voltage of the motor shaft 25 is discharged. The threshold value Vsref is determined in advance by an experiment, analysis, machine learning, or the like.

In the above-described embodiment, the discharge of the shaft voltage of the motor shaft 25 is detected when the filtered value Vsf is equal to or greater than the threshold value Vsfref. However, instead of this, the predetermined pulsation of the shaft voltage may be detected when the filtered value Vsf is equal to or higher than a threshold value Vsfref2 that is lower than the threshold value Vsfref. The threshold value Vsfref2 is a value slightly smaller than the maximum value of the filtered value Vsf when the transistors T11 to T16 of the inverter 50 are switched. The threshold value Vsfref2 is determined in advance by an experiment, analysis, machine learning, or the like. The predetermined pulsation of the shaft voltage in this case includes not only the fluctuation of the shaft voltage due to the discharge of the shaft voltage of the motor shaft 25 but also the fluctuation of the shaft voltage due to the switching of the transistors T11 to T16 of the inverter 50. In this case, the target applied currents Ica*, Icb* may be set in consideration of the magnitude relationship between the maximum value of the filtered value Vsf and the threshold value Vsfref. The target applied currents Ica*, Icb* may be uniformly set regardless of the relationship between the magnitudes. The threshold value Vsfref2 may be used instead of the threshold value Vsfref, and similarly, the threshold value Vsref2 may be used instead of the threshold value Vsref, as described above. The threshold value Vsref2 is determined in advance by an experiment, analysis, machine learning, or the like as a value slightly smaller than the maximum value of the shaft voltage Vs when the transistors T11 to T16 of the inverter 50 are switched.

In the above-described embodiment, the choke coils 48a, 48b are attached to the drive shafts 42a, 42b. However, the present disclosure is not limited thereto, and the choke coil may be attached to a power transmission path from the motor shaft 25 to the drive wheels DWa, DWb. For example, the choke coil may be attached to solely one of the drive shafts 42a, 42b, the choke coil may be attached to the counter shaft 31, or the choke coil may be attached to the motor shaft 25.

The correspondence between the main elements of the embodiment and the main elements of the disclosure described in the column of the means for solving the problems will be described. In the embodiment, the motor shaft 25 is an example of a “motor shaft”. The rotor 23 is an example of a “rotor”. The stator 24 is an example of a “stator”. The motor 22 is an example of a “motor”. The inverter 50 is an example of an “inverter”. The shaft voltage sensor 25s is an example of an “shaft voltage sensor”. The choke coils 48a, 48b are examples of “choke coils”. The ECU 70 is an example of an “application control device”. In addition, the gear mechanism 30 is an example of a “gear mechanism”. The differential gear 40 is an example of a “differential gear”. The drive shafts 42a, 42b are examples of “drive shafts”.

The correspondence between the main elements of the embodiment and the main elements of the disclosure described in the column of means for solving the problem is an example for specifically describing the embodiment for implementing the disclosure described in the column of means for solving the problem. Therefore, the elements of the disclosure described in the column of the means for solving the problem are not limited. That is, the interpretation of the disclosure described in the column of the means for solving the problem should be made based on the description in the column, and the embodiment is merely a specific example of the disclosure described in the column of the means for solving the problem.

Although the embodiment for implementing the above-described disclosure has been described, the above-described disclosure is not limited to the embodiment, and can be implemented in various forms within the scope of the spirit of the above-described disclosure.

The present disclosure can be used in a manufacturing industry of a drive device for an electrified vehicle.

What is claimed is:

1. A drive device for an electrified vehicle, the drive device comprising:
a motor having a rotor attached to a motor shaft and a stator around which a motor coil is wound;
an inverter configured to drive the motor through switching of a switching element;
a shaft voltage sensor configured to detect a shaft voltage of the motor shaft;
a choke coil attached to a power transmission path from the motor shaft to drive wheels; and
an application control device configured to apply a current to the choke coil to cancel at least a part of electromagnetic noise transmitted to the drive wheels through the power transmission path when a predetermined pulsation of the shaft voltage is detected based on a detection value of the shaft voltage sensor.

2. The drive device according to claim 1, wherein the application control device is configured to detect the predetermined pulsation of the shaft voltage when the detection value of the shaft voltage or a filtered value obtained by subjecting the detection value to filter processing reaches a threshold value or more.

3. The drive device according to claim 2, wherein the threshold value is determined in advance as a value that is larger than the detection value or the filtered value when the switching occurs in the inverter and that is smaller than the detection value or the filtered value when the shaft voltage is discharged.

4. The drive device according to claim 1, wherein:
the motor shaft is connected to the drive wheels via a gear mechanism, a differential gear, and a drive shaft; and
the choke coil is attached to any one of the motor shaft, a shaft of the gear mechanism, and the drive shaft.
